(19) United States
(12) Patent Application Publication
(10) Pub. No.: US 2015/0262310 A1
(43) Pub. Date: Sep. 17, 2015

(54) MERCHANT AGGREGATION THROUGH ACCOUNT ENTRY

(71) Applicant: MasterCard International Incorporated, Purchase, NY (US)

(72) Inventor: Justin Xavier Howe, San Francisco, CA (US)

(73) Assignee: MasterCard International Incorporated, Purchase, NY (US)

(21) Appl. No.: 14/215,383

(22) Filed: Mar. 17, 2014

(51) Int. Cl. G06Q 40/00; G06Q 20/40; G06Q 20/20

(52) U.S. Cl. CPC G06Q 40/12; G06Q 20/202; G06Q 20/40

(57) ABSTRACT

Electronic transactions involving a subject merchant location are identified with a test transaction of a predetermined known amount, on a predetermined date, drawn upon a known account number. In the case of merchants having multiple transaction terminals in a given location, the process can be repeated for each transaction terminal. Once the test transaction is identified in either the clearing or authorization records, the merchant data string that make up the test transaction message can then be used to identify all transactions from each terminal of that merchant location. Accordingly, that merchant location's transactions are thereafter positively identifiable for any purpose.

### BACKGROUND

1. Field of the Disclosure

The present disclosure relates to electronic transaction processing. More specifically, the present disclosure is directed to method and system for compiling the transactional volume of aggregate merchants.

2. Brief Discussion of Related Art

The use of payment devices for a broad spectrum of cashless transactions has become ubiquitous in the current economy, according to some estimates accounting for as much as two trillion dollars in transaction volume annually by one processor alone. The process and parties typically involved in consummating a cashless payment transaction can be visualized for example as presented in FIG. 1, and can be thought of as a cycle, as indicated by arrow 10. A device holder 12 may present a payment device 14, for example a payment card, transponder device, NFC-enabled smart phone, among others and without limitation, to a merchant 16 as payment for goods and/or services. The merchant 16 will be equipped with a Point-of-Sale (POS) transaction terminal 17 operative to interface with the payment device 14 initiate and execute cashless transactions.

For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets, or the like. The payment device 14 here is emblematic of any transaction device, real or virtual, by which the device holder 12 as payor and/or the source of funds for the payment may be identified.

In cases where the merchant 16 has an established merchant account with an acquirer 20, the merchant 16 communicates with the acquirer 20 to request payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is licensed by the network operator 22 to issue branded payment devices 14 on behalf of its customers (e.g., device holder 12) for use in transactions to be completed on the network. The issuer 24 also provides the funding of the transaction to the merchant 16 via the network operator 22 and acquirer 20 for transactions that it approves in the process described. The issuer 24 may approve or authorize the transaction request based on criteria such as a device holder's credit limit, account balance, or in certain instances, more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision by the issuer 24 to authorize or decline the transaction is routed through the network operator 22 and acquirer 20, ultimately to the merchant 16 at the point of sale. In a one-message based transaction system, the transaction is thus consummated, with payment routed between issuer 24 and acquirer 20 via the network operator. Alternately, in a two-message system, the approval of the transaction by the issuer 24 is subsequently settled or paid to the acquirer 20, who then reconciles with the merchant.

This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

The network operator 22 can further build and maintain a data warehouse that stores and augments transaction data for use in marketing, macroeconomic reporting, etc. To this end, transaction data from multiple transactions is aggregated for reporting purposes according to a location of the merchant 16. Additionally, one merchant 16 may operate plural locations, and each may have plural POS terminals to accept card transactions. Consider, for example, a chain or franchise having multiple business locations. These merchant locations are beneficially aggregated and assigned an aggregate merchant location identifier for reporting purposes.

Of all the data handled in the transaction process, the merchant's data tends to be the least stable and most difficult with which to deal. For example, the merchant's address as encoded into the terminal may be selected as a mailing address (e.g., a P.O. box; or the address of a corporate headquarters) rather than a physical location of the terminal installation. In some cases, a merchant 16 may choose to code their customer service telephone number in the name or address field by way of transmitting that information to the cardholder 12 when the data is forwarded with their statement 26. In still other cases, a merchant location may occupy space in more than one physical address, which is consolidated for their business use. Consider a brick & mortar storefront that is a consolidation of address nos. 500, 502 and 504. The merchant location may nominally operate under address no. 500, but still encode its POS terminals as one or more of the addresses 500, 502, 504. The address number discrepancy may inhibit the consolidation of transactions to that merchant.

A merchant 16 may change to a new acquirer 20, who may alter or truncate the merchant's name and/or address information in the terminal. Card-accepting POS terminals may be exchanged and re-deployed, for example among merchants 16 who are clients of the same acquirer 20, or among merchant locations within an aggregate of franchise merchant 16, without updating the current merchant location data in the terminal.

In cases where the merchant 16 uses a third party payment provider 18, e.g., a merchant services provider (MSP) of which DIGITAL RIVER is but one, or a payment facilitator, of which PAYPAL is but one, the third party provider information (e.g., name, address) will appear in the ISO 8583 data fields, not the merchant's data. Additionally, there remain in use a certain number of obsolete terminals, which do not code merchant name and address, but instead use a unique serial number associated with the terminal.

One of the challenges with merchant data is the fact that there is no universal merchant location identifier. Rather, the network operator 22 must build and maintain the data warehouse itself, derived from merchant data included in the transaction data delivered via the acquirer 20. Similarly, there is no reliable location identifier in the data received that indicates if a merchant location belongs to a chain or not, for example for aggregation purposes. Again, the network operator 22 augments transactions with this information, based on the received merchant name, the acquiring bank, and several other fields. The process of grouping merchant locations into sets of chain merchants is called “merchant aggregation” and maintaining the integrity of these aggregations is a challenge. Ultimately, the network operator 22 must rely on imperfect inference from the transaction data to perform its merchant aggregation.

Merchants 16 and acquirers 20 do not consistently or predictably submit their data in the same way, thus creating the need to monitor the integrity of this data. Merchants 16 can change acquirers 20; they open and close locations; they rebrand themselves—just to name a few of the challenges. When any of these or other changes to merchant data happen, the rules used to assign an identifier to a merchant location and/or associate that merchant location with an aggregate merchant location identifier often fail. This is because each perturbation of merchant data causes the generation of a new and unique merchant identifier. Even cursory human oversight of each and every merchant location would be prohibitively expensive considering the total number of merchants 16 accepting authorized payment devices 14, or even that subset of aggregate merchants whom the network operator 22 wishes to monitor.

Existing merchant aggregation efforts rely on text matching, address recognition, or even feedback from the merchant to properly group and/or classify merchants in the aggregate. However, no method to date can assure that every eligible merchant location is contained within the aggregate. Furthermore, a merchant point-of-sale (POS) terminal can be resold or transferred among merchants. If the POS terminal is not rebuilt properly before redistributing to a different merchant, techniques that look to the POS terminal identification data to aid in the aggregation may result in inaccuracies. Likewise, a disreputable merchant who intentionally selected their name so as to be mistaken for a different entity would be prone to misaggregation. A solution to this aggregate merchant data quality deficit problem remains wanting.

### SUMMARY

The instant application describes a solution to the problem of aggregate merchant data quality deficit.

Among the problems influencing the merchant data quality deficit is that, in the example of the largest merchants, they may use more than one acquirer 20 to process all of their transaction volume across their entire chain of stores. This may or may not be divided by merchant subsidiary, and may be without regard to plural transaction device 14 acceptance terminals at a given location. Each acquirer may have a different data format for merchant name and location. In some cases, multiple terminals, even those processed through the same acquirer 20 and in the same location of a given merchant 16, may have variations in data presentation.

A subject merchant location can be identified with a test transaction, including for example a predetermined known amount, processed on a predetermined date, drawn upon a known transaction card account number. In the case of merchants having multiple transaction terminals in a given location, the process can be repeated for each transaction terminal. Details of the test transaction, e.g., transaction amount, may be altered from one terminal to the next, in order to uniquely identify each terminal. Once the test transaction is identified in either the clearing or authorization records, the merchant data string that make up the test transaction message can then be used to identify all transactions from each terminal of that merchant location. Accordingly, that merchant location's transactions are thereafter positively identifiable for any purpose.

Therefore, provided according to the instant disclosure is a method of identifying a merchant location by record of electronic test transactions, the method comprising providing, to a first merchant, first account information for use in processing a test transaction through a transaction terminal of the first merchant at a first merchant location, the transaction terminal having first identifying information for association with card transactions processed using the transaction terminal. The first merchant is instructed to execute a test transaction using the transaction terminal in communication with a cashless transaction network operator and the first account information.

The test transaction is thereafter identified in transaction records of a cashless transaction network operator. The first identifying information of the transaction terminal is extracted from the identified test transaction. Accordingly, an association is made between the terminal identifying information of the test transaction and the first merchant location. This association is stored in a data warehouse of the network operator.

In a further embodiment of the present disclosure, the merchant operates a plurality of transaction terminals at the first merchant location, each transaction terminal having respective identifying information for association with card transactions processed therewith, the method further comprises instructing the first merchant to execute a plurality of test transactions using the first account information on each of the plural transaction terminals at the first merchant location. The plurality of test transactions are identified in transaction records of the network operator, and respective identifying information of the plurality of transaction terminals is extracted therefrom. An association is formed between the terminal identifying information of the test transactions and the first merchant location. This association is stored in a data warehouse of the network operator.

In a further embodiment of the present disclosure, identifying the test transaction comprises identifying, in the records of the network operator, a transaction having one or more of a card number of the first account information, a predetermined transaction amount, and a predetermined time or date when the transaction was executed.

In a further embodiment of the present disclosure, the first account information comprises an account number associated with an account funded to the extent of an amount of the test transaction, whereby the test transaction will be approved, and wherein the identifying the test transaction in the records of the network operator comprises identifying the transaction in the clearing records of the network operator. In an alternate embodiment of the present disclosure, the first account information comprises an account number associated with an account not funded to the extent of an amount of the test transaction, whereby the test transaction will be declined on authorization, and wherein the identifying the test transaction in the records of the network operator comprises identifying the transaction in the authorization records of the network operator. The first account information may include a virtual card number. The first account information may be uniquely associated with one of the first merchant, the first merchant location, or the transaction terminal.

In a further embodiment of the present disclosure, the method further includes executing the test transaction at a predetermined time of day, or on a predetermined periodic schedule.

Further provided according to the present disclosure is system for identifying a merchant location by record of electronic test transactions, the system comprising a processor, a network communication interface enabling the processor to communicate on a network, and a non-transitory, machine-readable storage medium. The storage medium stores thereon a program of instructions which, when executed by the processor, cause to processor to search an electronic data storage having a record of cashless transactions processed by a transaction network operator to identify transactions therein that include a predetermined first account information that had been provided to a first merchant location. The record of cashless transactions includes first identifying information that identifies the transaction terminal associated with each transaction. The processor further records an association between the first terminal identifying information included in the identified transaction including predetermined first account information, and the first merchant location.

In a further embodiment of the presently disclosed system, identifying the transactions comprises identifying a transaction having one or more of a card number of the first account information, a predetermined transaction amount, and a predetermined time or date when the transaction was executed. Identifying the transaction may comprise identifying the transaction in the clearing records of the network operator, or in the authorization records of the network operator.

The first account information may optionally be uniquely associated with one of the first merchant, a location of the first merchant, or a transaction terminal of the first merchant.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates schematically the process and parties typically involved in consummating a cashless payment transaction;

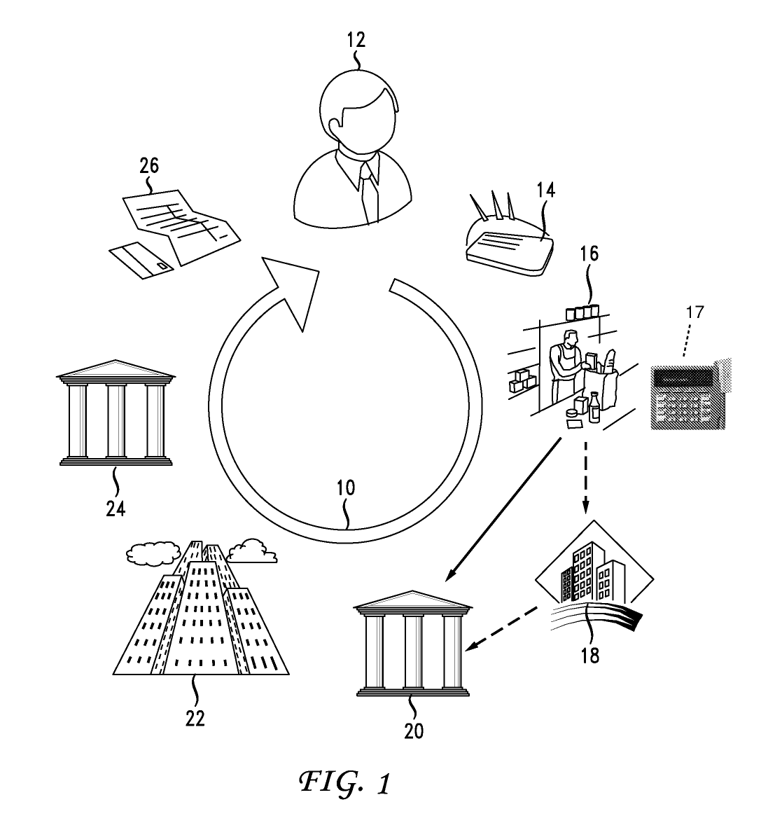

FIG. 2 illustrates a flowchart for a process of identifying a merchant location by account data entry according to the presently disclosed methods; and

FIG. 3 illustrates schematically a network-enabled computer for carrying out the methods of the present disclosure.

### DETAILED DESCRIPTION

All extant merchant aggregation methods are based upon the assumption that it is more efficient to infer the parent merchant from information in the authorization or clearing data stream, or with third-party data providers (e.g., yellow pages, Nielsen, etc.) than to obtain merchant aggregation data that is unknown to the payment network. The present disclosure provides a method of instead using a system of identifiable test transaction to identify particular merchant locations for aggregation or classification purposes.

In the four-party transaction system described above (cardholder, merchant, issuer, acquirer), the merchant is a client of the acquirer, and therefore the acquirer has the best data on the identity of the merchant. On the other hand, the network operator 22, who intermediates transactions between the acquirer and the issuer, does not have this information. The network operator 22 receives merchant information as embedded in the transaction message, for example per the ISO 8583 format. As noted, the merchant identity information contained in the transaction message is often unreliable, corrupted, or otherwise insufficient to uniquely identify the merchant location involved. In order to maintain payment integrity, each perturbation of merchant identifying data mandates the creation of a unique merchant ID number.

However, for certain uses of transactional information, it is necessary to identify the merchant location with certainty. For example, transaction information may be aggregated to compare the performance of one merchant to peers or competitors. To make this comparison, transaction originating from the merchant to be compared must be filtered and removed from the set. Accordingly, transactions originating from the target merchant must be identified. Similarly, an informed choice of peers in the competitive set requires knowledge of the identity and characteristics of those merchants used for comparison, in order to identify and isolate those transactions. It is also desirable to be able to aggregate transactions to a single aggregate merchant location having multiple transaction processing terminals, or across multiple merchant locations have relationship with one another, for example as a chain or franchise.

One solution to the identification problem can be found by seeding a subject merchant location to be identified with a test transaction of a predetermined known amount, on a predetermined date, drawn upon a known transaction card primary account number (PAN). The PAN may be a virtual card number (VCN). Therefore, the ISO 8583 signature of any terminal may be identified and linked to a known POS terminal, merchant, or merchant location, notwithstanding that the ISO 8583 fields of that terminal may bear no textual similarity to the actual terminal/merchant/location's information. In order for the transaction to be approved, and subsequently cleared or paid in clearing, the account on which the test transaction is drawn must be funded to the extent of the transaction. Absent funding, the transaction may be declined at the authorization phase, and the data will not appear in the clearing records. Alternate to funding the test account, the inquiry may be made into the authorization records, which are generally considered and separately searchable from the clearing records.

In the case of merchants having multiple transaction terminals in a given location, the process can be repeated for each transaction terminal. Details of the test transaction, e.g., transaction amount, may be altered from one terminal to the next, in order to uniquely identify each terminal.

Once the test transaction is identified in either the clearing or authorization records, the merchant data string that make up the test transaction message can then be used to identify all transactions from each terminal of that merchant location. Accordingly, that merchant location's transactions are thereafter positively identifiable for any purpose, including without limitation those described above.

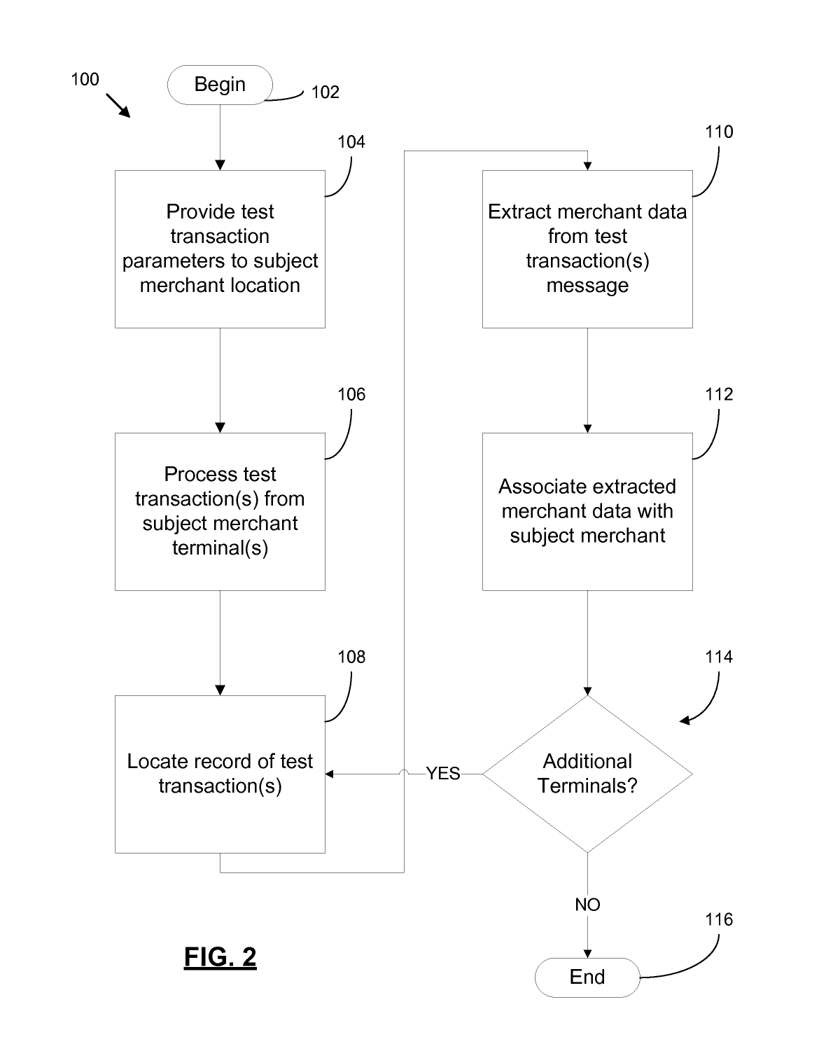

An exemplary process for carrying out the described method is illustrated by the flowchart, generally 100, of FIG. 2. The process begins at 102, and as a first step 104, the network operator 22 provides to the subject merchant certain test transaction parameters, to include at least a PAN on which to process the test transaction, and a predetermined transaction amount. In certain embodiments, one unique PAN/VCN may be provided to a specific merchant, merchant location, or terminal of a merchant/merchant location.

At step 106, a representative of the merchant location processes the test transaction through one or more transaction terminals in use at the subject merchant location. As already noted, one of two results of the test transaction(s) will occur. If the test account is funded, then the test transaction(s) will be approved, and payment will be made on the transaction when the subject merchant runs their periodic batching, typically daily, and submits the approved transactions for clearing and payment. The test transaction routine may be conducted regularly or routinely on a periodic scheduled basis (e.g., daily, weekly, etc.) by the merchant. The process may even be automated.

Thereafter, the test transaction can be located by reference to the clearing data. Alternately, if the test account is not funded, the transaction will be declined authorization. The record of the declined transaction can then be located among the authorization records. Either case provides for the test transaction to be identified at step 108. More specifically, the test transaction can be identified by the PAN or VCN used in the test transaction, and optionally, additionally by a time and date of the test transaction, and the dollar amount of the test transaction.

At step 110, the identifying information is extracted from the message carrying the test transaction, for example including a merchant ID number, or the ISO 8583 Name and address fields of the POS terminal. This identifying information, thus positively identified, is associated with the subject merchant at step 112. This process can be reiterated for more than one transaction terminal at the subject merchant's location, if any, at 114. The process of identifying a subject merchant's transactions is complete at 116.

It will be appreciated by those skilled in the art that the methods as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

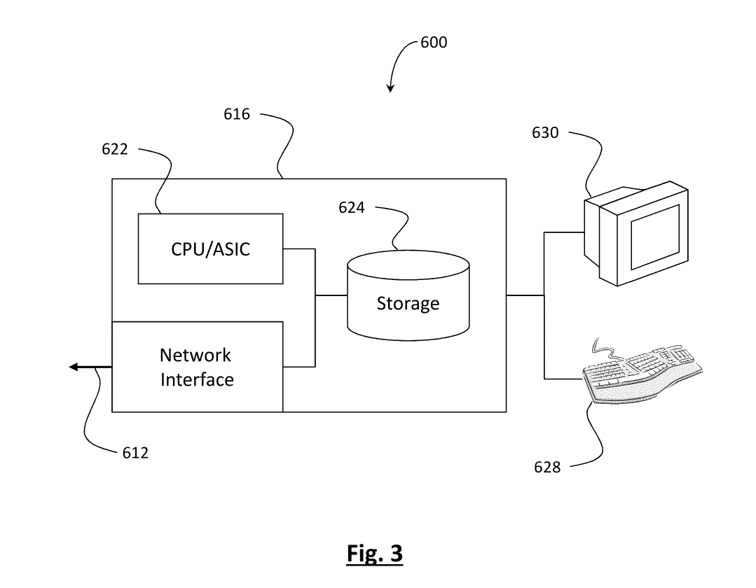

Turning then to FIG. 3, illustrated schematically is a representative computer 616 of the system, generally 600. The computer 616 includes at least a processor or CPU 622, which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases include a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a graphic user interface (GUI). The network operator 22 may also maintain a data storage 624, colloquially called a “data warehouse”, storing inter alia, transaction records, authorization records, and merchant location associations formed as a result of the present disclosure. The data warehouse storage 624 may be internal, as shown in FIG. 3, or external, and may be divided and/or duplicated.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of identifying a merchant location by record of electronic test transactions, the method comprising:
providing, to a first merchant, first account information for use in processing a test transaction through a transaction terminal of the first merchant at a first merchant location, the transaction terminal having first identifying information for association with card transactions processed using the transaction terminal;
instructing the first merchant to execute a test transaction using the transaction terminal in communication with a cashless transaction network operator and the first account information;
identifying the test transaction in transaction records of a cashless transaction network operator, and extracting therefrom the first identifying information of the transaction terminal;
forming an association between the terminal identifying information of the test transaction with the first merchant location; and
storing the association in a data warehouse of the network operator.

2. The method according to claim 1, wherein the merchant operates a plurality of transaction terminals at the first merchant location, each transaction terminal having respective identifying information for association with card transactions processed therewith, the method further comprising:
instructing the first merchant to execute a plurality of test transactions using the first account information on each of the plural transaction terminals at the first merchant location;
identifying the plurality of test transactions in transaction records of the network operator, and extracting therefrom the respective identifying information of the plurality of transaction terminals;
forming an association between the terminal identifying information of the test transactions with the first merchant location; and
storing the association in a data warehouse of the network operator.

3. The method according to claim 1, wherein the identifying the test transaction comprises identifying, in the records of the network operator, a transaction having one or more of a card number of the first account information, a predetermined transaction amount, and a predetermined time or date when the transaction was executed.

4. The method according to claim 1, wherein the first account information comprises an account number associated with an account funded to the extent of an amount of the test transaction, whereby the test transaction will be approved, and wherein the identifying the test transaction in the records of the network operator comprises identifying the transaction in the clearing records of the network operator.

5. The method according to claim 1, wherein the first account information comprises an account number associated with an account not funded to the extent of an amount of the test transaction, whereby the test transaction will be declined on authorization, and wherein the identifying the test transaction in the records of the network operator comprises identifying the transaction in the authorization records of the network operator.

6. The method according to claim 1, wherein the first account information comprises a virtual card number.

7. The method according to claim 1, wherein the first account information is uniquely associated with one of the first merchant, the first merchant location, or the transaction terminal.

8. The method according to claim 1, further comprising:
executing the test transaction at a predetermined time of day, or on a predetermined periodic schedule.

9. A system for identifying a merchant location by record of electronic test transactions, the system comprising:
a processor;
a network communication interface enabling the processor to communicate on a network; and
a non-transitory, machine-readable storage medium, storing thereon a program of instructions which, when executed by the processor, cause to processor to
search an electronic data storage having a record of cashless transactions processed by a transaction network operator to identify transactions therein that include a predetermined first account information, wherein the predetermined first account information had been provided to a first merchant location, and wherein the record of cashless transactions includes first identifying information that identifies the transaction terminal associated with each transaction; and
record an association between the first terminal identifying information included in the identified transaction including predetermined first account information, and the first merchant location.

10. The system according to claim 9, wherein identifying the transactions comprises identifying a transaction having one or more of a card number of the first account information, a predetermined transaction amount, and a predetermined time or date when the transaction was executed.

11. The system according to claim 9, wherein identifying the transaction comprises identifying the transaction in the clearing records of the network operator.

12. The system according to claim 9, wherein identifying the transaction comprises identifying the transaction in the authorization records of the network operator.

13. The system according to claim 9, wherein the first account information is uniquely associated with one of the first merchant, a location of the first merchant, or a transaction terminal of the first merchant.
